(19) United States
(12) Patent Application Publication
(10) Pub. No.: US 2012/0102802 A1
(43) Pub. Date: May 3, 2012

(54) DEVICE FOR MARKING AN ITEM WITH A VIEW TO IDENTIFYING SAME

(75) Inventors: Tamas Lodi, Budapest (HU); Alain Favier, Nogent-Sur-Marne (FR)

(73) Assignee: EXAQTWORLD, Joinville Le Pont (FR)

(21) Appl. No.: 13/379,093

(22) PCT Filed: Jun. 18, 2010
(86) PCT No.: PCT/FR2010/051227

§ 371 Date: Dec. 19, 2011

(30) Foreign Application Priority Data
Jun. 18, 2009 (FR) 0954129
Aug. 27, 2009 (FR) 0955851

(51) Int. Cl. G09F 3/12

(52) U.S. Cl. 40/662

(57) ABSTRACT

A device (10; 20) for marking an item for the purpose of its identification, includes: a tip (14; 24) designed to pass through the item to be marked or a packaging containing this item, a head (12; 22) that has two opposite surfaces, with the tip extending from a first surface of the two surfaces, characterized in that on the side of the second opposite surface, the head has a printed zone that is protected by a transparent protective cover (16; 30).

The invention relates to a device for marking an item for the purpose of its identification. More particularly, the invention relates to a device for protection against theft, in particular against theft from displays, of an item.

To effectively combat theft from displays and more particularly the theft of certain products such as textile products (shirts, sweaters, undergarments, pants, lingerie, ties, socks, t-shirts, dresses, coats, hats, shoes, polo shirts, skirts, i.a.), the retailers use anti-theft tags (also called beeps, stickers, or “EAS tags” in English terminology) in a known manner. These anti-theft tags trigger an anti-theft portal or an RFID-type surveillance system arranged at access points (entrances/exits) of a selling location such as a super- or hyper-type store, a boutique, a specialty store, a duty-free shop, a department store, a museum, a video club, a pharmacy, as well as any other store or entity that sells or displays self-service items that are susceptible to being stolen or removed without authorization.

These tags are generally formed by two parts:
One element that contains a locking system and an active or passive element that triggers antennae or detection portals that are commonly installed at access points of the stores,
A nail that passes through the item to be protected (for example, the fabric of an article of clothing) or else the cardboard or the plastic of the blister packs.

Several companies propose printing a logo or a particular inscription on the body or on the nail of the tag. In general, this printing is done by tampography. Tampography is an incision process that uses a flat steel plate that is etched with acid, called the printing plate, which is filled with ink. An elastic and smooth buffer that is made of non-absorbent silicone rubber is then used to collect a layer of ink from the printing plate and to transfer it to the substrate to be printed.

This process, which is very common in the industry, does not make it possible to implement printing of photographic quality or printing that relies on multiple colors being mixed with one another and overlapping. It is generally limited to non-complex forms with one or two colors (a logo, a trademark, a company name), even if, in principle, a tampography machine can print five or more colors.

This method implements printing that withstands mechanical wear and tear but proves to be quite costly, however.

Other printing methods, such as silk-screening, make it possible to carry out very complex printing, such as photocopies, multi-color images, etc., but cannot implement printing on rigid and thick supports such as anti-theft tags, regardless of whether this is on the nail or the body of the tag.

The users of anti-theft tags that have been pre-printed by tampography or by a similar process printing a single-color or multi-color image on the body or on the nail of the anti-theft tag are confronted with another problem: these users have been able to note a rapid deterioration of the pre-printed image because the anti-theft tags are recycled numerous times in the stores because of their service life (5 to 10 years) and are thereby subjected to frequent handling that creates wear and tear. Actually, the tags are in contact with the unlocking mechanism that is installed at the register, and they are then subjected to various types of mechanical friction in contact with one another in the tubs where they are collected before being reinstalled on other commercial items.

The purpose of the invention is to eliminate at least one of the above-mentioned drawbacks by proposing a device for marking an item for the purpose of its identification, comprising:
A tip that is designed to pass through the item to be marked or a packaging that contains this item,
A head that has two opposite surfaces, with the tip extending from a first surface of the two surfaces,
   characterized in that on the side of the second opposite surface, the head has a printed zone that is protected by a transparent protective cover.

The printed zone is thus protected mechanically (wear and tear, soiling, dust, spraying of liquids, moisture . . . ) by the presence of the cover opposite the second surface of the head that, owing to its transparent nature, makes it possible to visualize the printed inscriptions.

To the extent that the printed zone is protected, in particular against wear and tear, the material of the printing zone can be selected to adapt itself in a particularly satisfactory way to the printing processes that provide complex, varied printing that relies on numerous colors and that is of high quality.

It is therefore no longer necessary to be limited only to the printing techniques whose printing withstands wear and tear, of the tampography type.

However, providing that the second surface of the head is directly printed by tampography and that the thus printed zone is protected by the cover opposite makes it possible to considerably extend the service life of the inscriptions (text, drawings, . . . ) that appear in the printing zone.

According to a variant embodiment, the inside surface of the cover that is oriented opposite the second surface of the head carries the printed zone(s). Thus, the inscriptions are printed backwards on this surface so that they are visible from the outside of the cover when one looks through its outside surface.

It will be noted that the device briefly disclosed above is particularly suited to protecting one or more items against theft.

It can, however, be used in a more general way to mark items that are not necessarily to be sold.

According to one characteristic, the head comprises at least one element that carries the printed zone and that is arranged opposite the protective cover.

Thus, the element(s) that carry(ies) the printed zone(s) is/are inserted between the second surface of the head and the transparent cover.

The inscriptions that are present in the printed zone(s) are therefore visible from the outside and protected from external damage, which increases the service life thereof.

According to one embodiment, a single printed element is inserted between the second surface of the head and the cover, whereby this element has, for example, dimensions that are similar to those of the cover.

However, several printed elements of small dimensions can alternately be arranged instead of a single element and, for example, in the same plane.

According to one characteristic, the head has a housing on the side of its second surface, with said at least one carrier element of the printed zone being positioned in the housing.

This housing whose dimensions are adapted to those of the printed element or the set of printed elements makes it possible to accommodate it or to accommodate them and to keep it or them in a stationary position before placing the cover on top.

According to one characteristic, said at least one carrier element of the printed zone has the shape of a token.

Such a shape is particularly simple to manipulate.

According to one characteristic, said at least one carrier element of the printing zone is arranged in a removable manner on the second surface of the head.

The printed element(s) is/are thus interchangeable based on circumstances, requirements, and applications provided.

According to one characteristic, the printed zone is carried directly by the head, and, for example, by the second surface that is opposite to the head.

According to one characteristic, the protective cover is attached in a removable manner on the head, for example by clamping, screwing, or by interlocking.

Thus, the cover can be removed and reinstalled at leisure.

This particular feature offers the advantage of being able to replace the printed element(s) positioned between the cover and the second surface of the head by one or more other printed elements.

According to one characteristic, the protective cover is attached permanently on the head, for example by welding or gluing.

According to one characteristic, the protective cover has an outside surface that is opposite to an inside surface that is opposite the second surface of the head, with the outside surface having one of the following geometries: flat, convex, concave, or convex and concave.

The outside surface of the cover that is visible from the outside can have various geometries according to the desired effects.

The outside surface can thus be flat, convex, or else concave, or even both convex and concave.

The desired visual effect can consist in deforming the printed inscriptions (text and/or image) that are carried by the element(s) or carried directly by the second surface of the head, for example by enlarging them.

It will be noted that the cover can, according to one variant, be filled with a liquid or viscous gel that flows slowly when it is moved and that can be colored.

This liquid/gel that may or may not be colored can include one or more floating decorative objects that move based on the movements imposed on the cover.

According to one variant embodiment, the tip and the cover extend axially or relative to the first and second surfaces of the head, with at least one extension element extending axially, from the second surface, beyond the protective cover, so as to protect the cover relative to a contact with an outside object.

Said at least one extension element has an axial dimension or height that is greater than that of the cover so that in the case of contact with an outside object (other marking device, object that is part of the environment in which the device is used . . . ), said at least one extension element comes into contact with the object and not the cover.

The cover is thus protected mechanically relative to the outside, which prevents it from becoming deteriorated (for example, scratched) for example when the device falls on a surface or is rubbed against a surface (table, ground, . . . ).

To protect the cover, one or more extension elements are provided whose dimensions and arrangement are to be adjusted.

Thus, if several elements are taken into consideration, they can be distributed on the periphery of the cover. They can, for example, be arranged in such a way as to all together surround the cover at least partially.

Alternately, by itself, a single extension element can be arranged at the periphery of the cover and can, for example, partially or completely surround the cover.

According to one characteristic, said at least one extension element takes the form of a peripheral flange that is arranged around the cover.

According to one characteristic, the device comprises at least one active or passive element that can emit electromagnetic waves toward the outside of the device or can receive them.

Thus, the element(s) that is/are able to work with a complementary anti-theft protection/detection system (example: anti-theft portal) and to trigger an alarm are housed in the device.

The element that is carried by the device is, for example, a passive element that receives electromagnetic waves when it is located close to the complementary system.

Such a passive element is, for example, a resonant electrical circuit that resonates, in a known manner, under the action of exciting waves emitted at the resonance frequency of the circuit.

According to one variant, the protection device according to the invention does not comprise an active or passive element, with only the protective body with which it works mechanically comprising such an element.

According to one characteristic, the device comprises at least one liquid-filled cartridge that is able to be perforated. This characteristic is used in combination with a locked protective element to confine the item that is to be protected.

In the event of an attempt to separate the device and the body, the jacket of the cartridge that contains the liquid, such as an ink, is pierced, which spreads the liquid on the item.

The invention also has as its object a unit for anti-theft protection of an item that comprises a marking/protection device as briefly disclosed above and a protective body that is provided, on the one hand, with an opening for inserting the tip of the device therein, and, on the other hand, locking means for preventing the removal of the tip after its insertion.

The protective body or box is provided for working with the protection device with a tip as soon as the tip has passed through the item to be protected or the packaging that contains it.

The two constituent parts of the protection unit are then assembled and locked in such a way that the unit is inseparable from the item to be protected.

The sole means for removing the protection unit from the item is then to use an unlocking means that is conventionally installed in the cash registers of the store where the item is offered for sale.

The invention also has as its object a unit for anti-theft protection of an item that comprises:
A head that has two opposite surfaces and a tip that is designed to pass through the item to be protected or a packaging that contains this item, with the tip extending from a first surface of the two surfaces,
A protective body that is provided with, on the one hand, an opening for inserting the tip therein and, on the other hand, locking means for preventing the removal of the tip after its insertion, with a printed zone being located on the protective body and protected by a transparent protective cover.

In this embodiment, the protective body works with the head that is provided with the tip, as in the embodiment presented above.

The two constituent parts of the unit are then assembled and locked in such a way that the unit is inseparable from the item to be protected.

In this embodiment, the printed zone and the transparent protective cover are carried by the protective body and not by the head.

Thus, the protective body that is equipped with the printed zone is arranged in front of the item or the packaging that contains this item, and the head that is equipped with the tip is arranged behind or inside the latter.

This arrangement proves to be advantageous to the extent that the head is less thick than the body and therefore has a smaller space requirement, which makes it possible to be placed more easily behind or inside the item or the packaging that contains this item.

By way of example, the head can be housed more easily behind the fabric of a piece of clothing than the protective body.

According to one characteristic, at least one carrier element of the printed zone is arranged between the protective body and the protective cover.

This arrangement is particularly simple to produce since the element that carries information and the protective cover are located on a protective body of the known type.

According to one variant, the element that carries information is omitted, and the printed zones is/are directly carried by the protective body, in particular by an external surface of the latter.

According to one characteristic, the protective body comprises a surface in which are located the opening for inserting the tip and an opposite surface where the printed zone and the protective cover are located.

Other characteristics and advantages will emerge during the following description, provided only by way of nonlimiting example and given with reference to the accompanying drawings, in which:

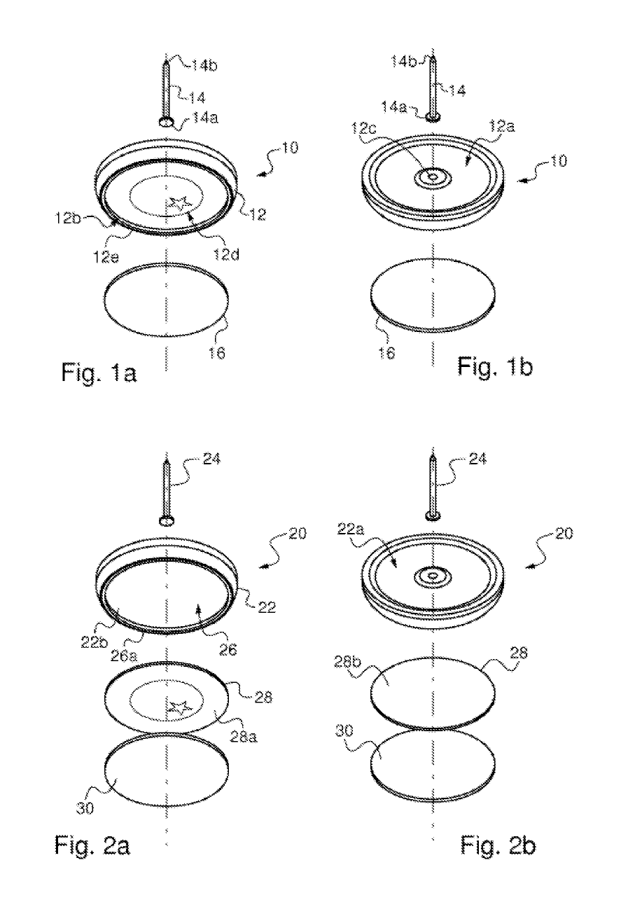

FIGS. 1a and 1b are exploded diagrammatic views of a device according to a first embodiment of the invention;

FIGS. 2a and 2b are exploded diagrammatic views of a device according to a second embodiment of the invention;

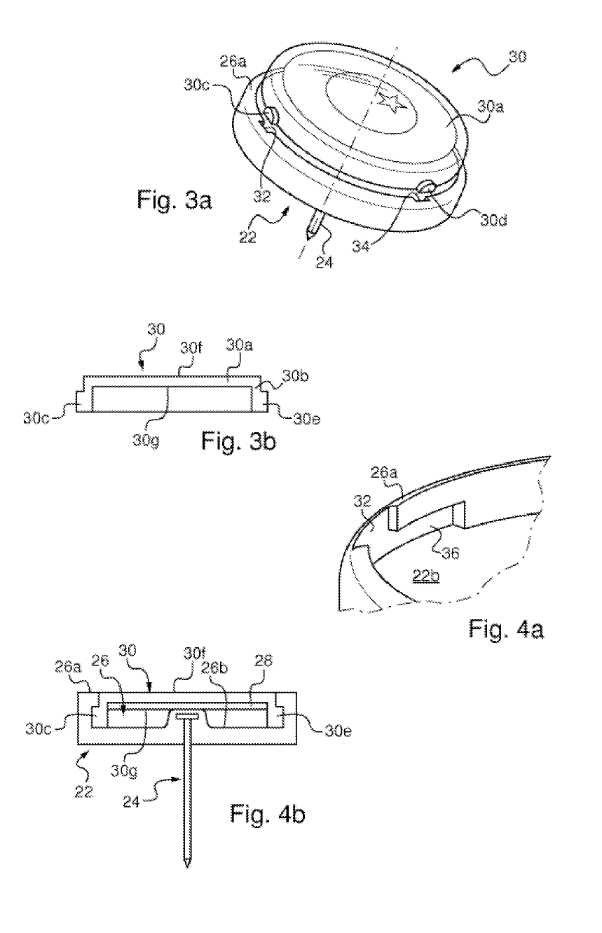

FIG. 3a is a diagrammatic top perspective view that shows a cover during its mounting on a device according to the invention;

FIG. 3b is a diagrammatic axial cutaway view of the cover of FIG. 3a;

FIG. 4a is a diagrammatic partial perspective view that shows the interior of the device on which the cover of FIGS. 3a and 3b is mounted;

FIG. 4b is a diagrammatic axial cutaway view of a complete device according to the invention after the cover is mounted;

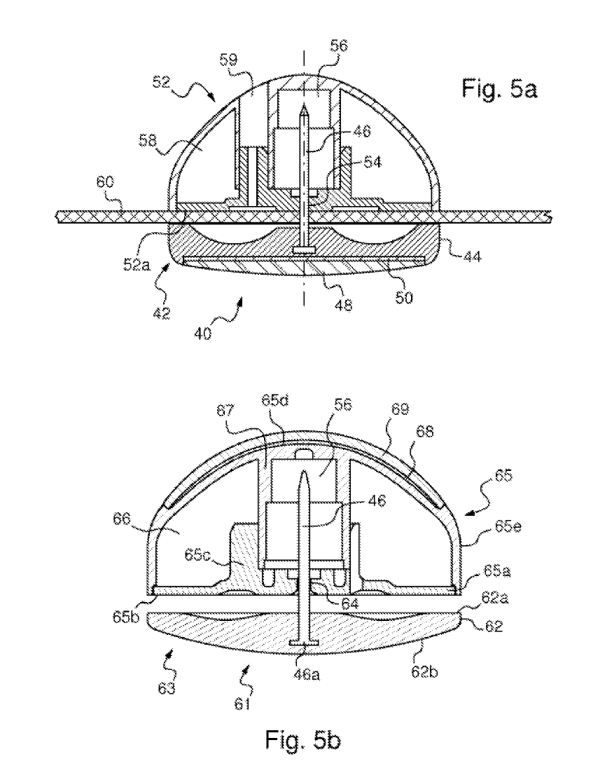

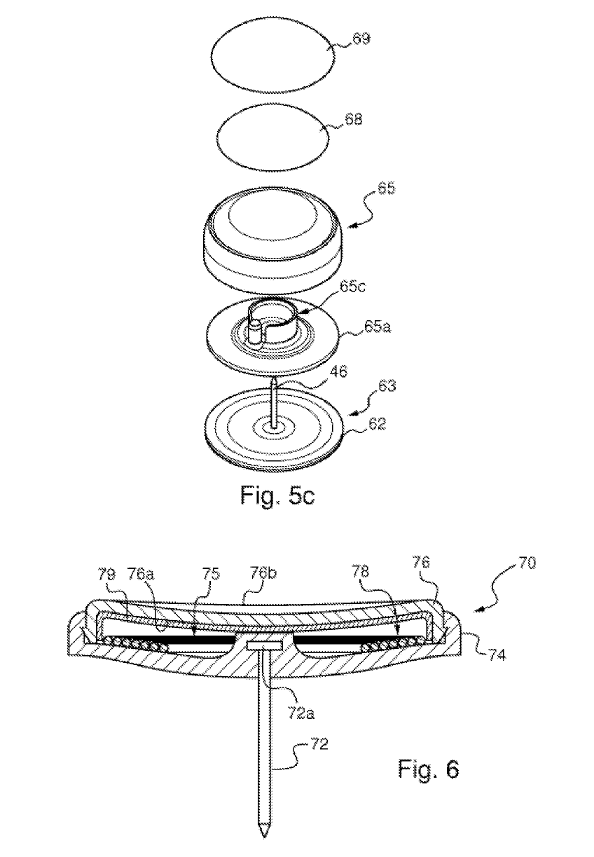

FIG. 5a is a diagrammatic axial cutaway view of a protection unit that comprises a device that is combined with a protective body;

FIG. 5b is a variant embodiment of the protection unit of FIG. 5a;

FIG. 5c is an exploded diagrammatic view of the protection unit that is illustrated in FIG. 5b;

FIG. 6 is a diagrammatic axial cutaway view of a device according to a first variant embodiment;

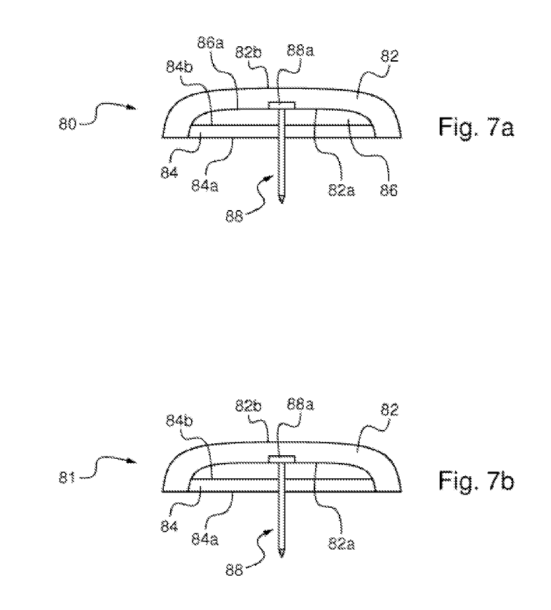

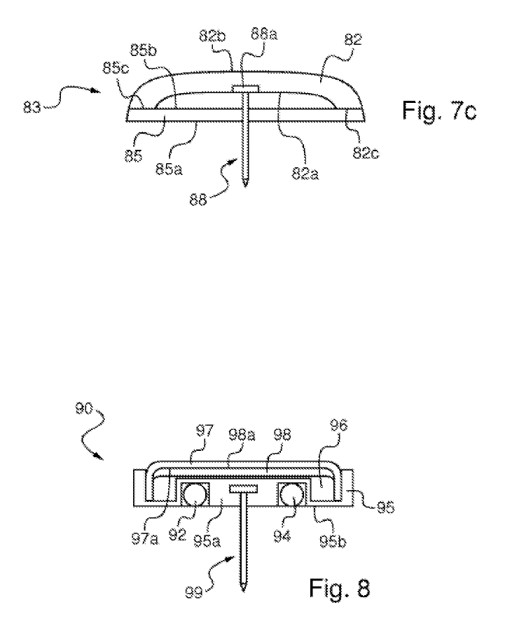

FIG. 7a is a diagrammatic axial cutaway view of a device according to a second variant embodiment;

FIGS. 7b and 7c are diagrammatic views that show other variant embodiments of the device according to the invention;

FIG. 8 illustrates a variant of a device that comprises two ink cartridges;

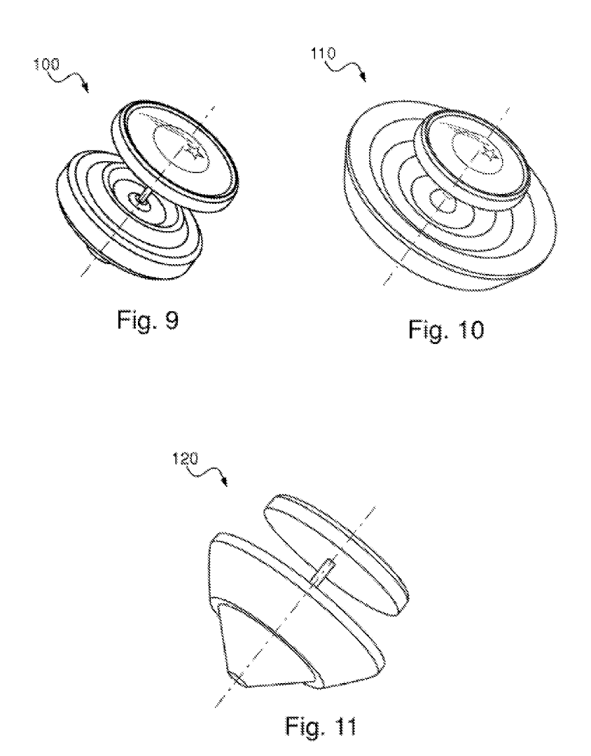

FIGS. 9 to 11 illustrate the combination of a marking device according to the invention with several different bodies;

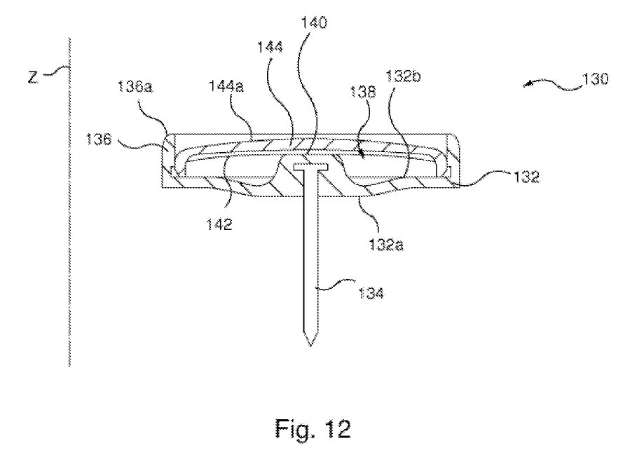

FIG. 12 is a diagrammatic axial cutaway view of a device according to yet another variant embodiment of the invention.

As shown diagrammatically in FIG. 1a, a device 10 according to a first embodiment of the invention comprises a head 12 that has two opposite surfaces, a first surface 12a that can be seen in FIG. 1b and a second opposite surface 12b.

The device 10 also comprises a tip 14 that comprises two opposite ends, namely a first end 14a that is designed to be kept inside the head 12 and an opposite end 14b that is tapered in such a way as to be able to perforate different materials such as fabric, cardboard, . . . .

As shown in FIGS. 1a and 1b, the tip 14 is equipped at its end 14a with a shoulder. The tip is mounted inside the head 12 from the second surface 12b of the latter and emerges via the first opposite surface 12a through an opening 12c whose diameter is less than the diameter of the shoulder that is provided at the end 14a of the tip.

Thus arranged, the tip extends from the first surface 12a of the head essentially perpendicular to the latter.

In this embodiment, the head comprises a surface 12d that exhibits a printed zone on the side of its second opposite surface 12b.

The surface is made of, for example, plastic material just like the head 12 itself.

The zone of the surface 12d is, for example, printed by a printing process such as tampography, and even by other printing techniques.

It will be noted that the surface 12d on which the printing is done is attached to the surface 12b of the head after the tip 14 has been installed.

It will be noted that, according to a variant that is not shown, the second surface 12b of the head is printed directly without it being necessary to provide the surface 12d.

The head has an internal housing whose flange 12e is seen in FIG. 1a.

The head also comprises a transparent protective cover 16 that is designed to be mounted on the head 12 so as to protect the printed zone 12d, while making it possible to see it.

This cover 16 that in some way forms a protective window is attached in a removable or permanent way to the head 12 of the device according to the usage provided and the possibilities for reusing the printed zone.

The cover thus can be screwed, gripped, interlocked, or else welded or glued to the head.

The cover can be made of transparent plastic material such as polycarbonate or else glass or, in a more general way, in any other transparent material that makes it possible to provide protection against wear and tear, moisture and various other types of damage.

It will be noted that the device 10 makes it possible to mark an item such as an item of commercial merchandise (for example, textile products such as shirts, sweaters, undergarments, pants, lingerie, ties, socks, t-shirts, dresses, coats, hats, shoes, polo shirts, skirts, . . . ) for the purpose of its identification.

Actually, the tip 14 of the device 10 is designed to pass through the item that is to be marked or else, when this item is contained in packaging, through the packaging itself.

After having passed through the item or packaging, the device is kept in position on the latter using a body that is arranged on the side of the item or packaging where the tip is taken out so as to lock the latter in said body.

Such a body is shown in, for example, FIG. 5a, which will be described subsequently but which can, in a very simple version, comprise only means designed to mechanically lock the tip of the device so as to prevent its removal.

The device that is illustrated in FIGS. 1a and 1b can be used as a device for protection against the theft of an item when it is combined with a protective body such as the one that is shown in FIG. 5a or the like.

FIGS. 2a and 2b diagrammatically illustrate the exploded views of a device according to a second embodiment of the invention.

The device 20 comprises, just like the device 10 of FIGS. 1a and 1b, a top 22 that has two opposite surfaces 22a and 22b, as well as a tip 24 that extends from the first surface 22a in a way that is essentially perpendicular to the latter.

The mounting of the tip 24 in the head 22 is identical to what was explained with reference to FIGS. 1a and 1b for the tip 14 that is installed in the head 12.

The same holds true, moreover, for the other characteristics and advantages that are linked to the head and to the tip illustrated in FIGS. 1a and 1b.

As shown in FIG. 2a, the device 20 comprises, on the side of its second opposite surface 22b, a housing 26 that is delimited by a peripheral flange 26a and by a bottom that constitutes the second surface of the head.

Like the device 10, the head 22 of the device 20 has an essentially circular shape although other shapes can be considered (square, hexagonal, oblong, . . . ).

The device 20 also comprises at least one element 28 that carries a printed zone on one of its surfaces.

The printed zone can constitute the entire surface in question or only a portion.

The printing of inscriptions (text, image, drawing, . . . ) by a known printing method is done directly on the surface of the element. It could be considered, however, that the printing is done on an intermediate part that would then be connected to the surface of the element.

This separate element that is unique in the example illustrated in FIGS. 2a and 2b is arranged between the second opposite surface of the head 22 and a transparent protective cover 30 analogous to the cover 16 of FIGS. 1a and 1b.

The printed element 28 carries the printed zone on a first surface 28a that is designed to be arranged opposite the protective cover 30.

The element 28 comprises a second opposite surface 28b (FIG. 2b) that is designed to be arranged opposite the second surface 22b of the head and, more particularly, opposite the bottom of the housing 26 when the element 28 is positioned inside the latter.

It will be noted that the element 28 has, for example, the shape of a token or a pellet that has the particular feature of being very easy to manipulate and is light.

This element 28 can be placed in the housing 26 without being attached there, in such a way as to be able to remove it, if necessary.

This removable nature of the element 28 is particularly useful when it is desired to replace it by another element that is, for example, the bearer of a different printed zone.

It will be noted that the element 28 can be replaced in an alternative way by several elements that each carry a fraction of a printed zone, and when all of these elements are positioned on the head 22, the set of fractions of the printed zones reconstitutes the printed zone of the element 28 of FIG. 2a.

These elements can assume complementary shapes relative to one another in such a way as to reconstitute the shape of the element 28, and even to assume different shapes.

It will be noted that according to a variant, not shown, several elements analogous to the element 28 can be superposed one above the other and placed in the housing 26.

For this purpose, the depth of the housing and the thickness of each element are adapted.

This arrangement makes it possible, for example, to provide a device with several printed elements and to be able to change the printed element at leisure based on the circumstances and requirements without needing to constitute a separate stock of such elements with all of the drawbacks that this comprises.

The device thus contains several interchangeable elements.

When the carrier element of the printed zone is installed in the housing, the cover 30 is attached to the head 22 in an at least temporary manner.

Actually, when the printed element 28 is placed in a removable way in the head 22, the protective cover is to be attached in a removable manner on the latter in order to easily have access to the printed element.

In one variant embodiment where it is not necessary to have access to the printed element 28, the protective cover is, for example, attached in a permanent way to the head, either by gluing or by welding, or by any other attachment means that is known to one skilled in the art.

It will be noted that the element 28 in the shape of a token can be made of different types of materials such as plastic, paper, cardboard or, in a more general way, any material that is able to be printed by any printing process, and, for example, by typography, by an offset printing technique, by flexography, by silk-screening, by a digital printing technique, . . . .

FIGS. 3a, 3b, 4a and 4b diagrammatically illustrate the mounting of a protective cover on a head of a device according to the invention.

It will be noted that such a cover equips the device 20 of FIGS. 2a and 2b.

The cover 30 that is illustrated in FIGS. 3a and 3b comprises a body 30a, for example with an approximately circular shape from which a skirt 30b extends in a perpendicular manner and which imparts a form of hollow plug to the entire cover.

The cover is provided with attachment means that are designed to work with the head 22. More particularly, attachment means are provided on the skirt 30b, for example on the external surface of the latter, and they have the shape of projections or lugs.

The cover comprises, for example, four projections of which only two, denoted 30c and 30d, are shown in FIG. 3a, with FIG. 3b illustrating a third projection 30e.

These projections are arranged, for example, denoted two by two in a diametrically opposed way.

The head 22 comprises, in the peripheral flange 26a (FIG. 4a diagrammatically illustrates in perspective an internal partial view of the peripheral flange 26a of the head 22), several openings of shapes corresponding to those of the projections of the cover 30 and arranged in a corresponding way to the latter as illustrated in FIG. 3a where two openings 32 and 34, in some way forming catches in the flange, are provided.

It will be noted that the opening 32 that is made in the flange extends over the entire height of the latter and that a recess 36 is provided at the base of the flange that is peripheral 26a so as to make between the latter and the bottom of the housing 22b a space of dimensions that correspond to those of the projections of the cover.

When the cover 30 is positioned as shown in FIG. 3a with projections opposite the openings of the head, the cover can be introduced into the housing following a vertical thrust until coming into contact with the bottom 22b of the latter.

Thus positioned, the projections of the cover are arranged against the bottom of the housing 22b and opposite the recesses 36 illustrated in FIG. 4a.

Thus, a simple rotation of the cover by several degrees makes it possible to engage the projections inside these recesses and to lock the cover in this position, thus preventing any axial withdrawal from the latter.

FIG. 4b illustrates the arrangement that is achieved when the printed element 28 (for example the token) is positioned in the housing 26 that is provided in the head 22 and when the transparent cover 30 is secured in a removable manner to the head 22 as described above.

It will be noted that the cover can be temporarily secured by other attachment means than the one shown in the Figures and, for example, by screwing.

Thus, a thread can be located on the outside surface of the skirt of the cover, and an additional threading can be provided on the inside surface of the flange 26a of the head.

As shown in FIGS. 3b and 4b, the protective cover has an outside surface 30f opposite an inside surface 30g, which is arranged opposite the printed element 28, and, in particular, the surface of the latter that is printed.

It will be noted that in the example that is illustrated in the figures, the outside surface 30f is flat, just like the inside surface 30g.

However, in other embodiments, the outside surface can be convex, concave, and even both convex and concave, which is reflected by an alternation of convex and concave zones, and, for example, by a wavy surface.

It will also be noted that the arrangement that is illustrated in FIGS. 3a, 3b, 4a, and 4b is entirely adapted to the device 10 of FIGS. 1a and 1b that does not comprise (a) separate printed element(s).

Furthermore, according to another variant that is not shown in the figures, the zone that carries the printed data (text, drawings, . . . ) can be the inside surface 30g of the cover, and the information is then printed backwards in such a way that an individual located on the side of the outside surface 30f can read the printed information.

In this case, the information is not printed on the second surface of the head as in the device of FIG. 1a.

This information can be, for example, a logo or a trademark of a commercial item or a company.

FIG. 5a diagrammatically illustrates in axial cutaway a unit 40 for marking an item according to the invention.

This unit also comprises suitable means for making it a unit for protection against the theft of an item, and, in particular, against theft from displays.

In particular, the unit 40 comprises a device for marking an item 42 that is similar to the devices mentioned above with reference to FIGS. 1 to 4.

The device 42 can actually take the form of any of the devices described above.

Thus, the device 42 comprises a head 44 that is equipped with a tip 46 and a transparent cover 48 that is designed to protect a printed zone that is placed behind the cover or on the inside surface of the latter.

As shown in FIG. 5a, a carrier element of the printed zone 50 is inserted between the cover 48 and the head 44. This element is analogous to, for example, the element 28 of FIGS. 2a and 2b.

It will be noted that the cover or protective window 48 has a convex outside surface in this embodiment.

The unit 40 also comprises a body 52 that forms a box and that comprises means that are provided for working at least mechanically with the device 42.

In particular, the body 52 is equipped with an opening 54 through which the tip 46 of the device 42 is inserted.

As shown in FIG. 5a, the box 52 has, for example, an essentially hemispherical shape and has an essentially flat surface 52a that is arranged in an equatorial plane, with the opening 54 being provided in this surface.

The box 52 encloses a cavity 56 in which ball locking means are arranged. Several balls are placed in a funnel inside the cavity, in the same plane, and they make between them a space for accommodating the tip 46.

When the tip is inserted into the space between the balls, the balls settle in the convergent part of the funnel. Any attempt at removing the tip axially tends to make the balls sink further into the convergent part of the funnel and therefore to lock the tip.

It will be noted that the balls are metal, and, more particularly, they are made of a magnetic material, which makes it possible to extract them from the convergent part of the funnel under the action of an external magnetic field.

On the periphery of the cavity 56, the box 52 also comprises an annular chamber 58 in which an element, and even several elements, for example a passive element, is arranged, i.e., one that is able to receive electromagnetic waves that originate from a source external to the unit 40.

Such an element can take the form of, for example, a resonant LC-type circuit.

In an alternative way, the box can contain one or more active elements, i.e., that are able to emit electromagnetic waves to the exterior of the device.

It will be noted that such active or passive elements are, for example, coils with ferrite, with or without a capacitor, LCR circuits, magnetic filaments, RFID-type circuits equipped with an active or passive memory chip, . . . .

Via the transmission of electromagnetic waves, this or these elements work(s) with a detection system, such as a portal or an antenna, placed at an access point of the store and where the item(s) to be protected is/are put out for sale, so as to trigger an alarm for detection of the protection unit at the access point.

The box 52 also comprises stiffening means (example: ribs) arranged between the chamber 58 and the cavity 56 so as to reinforce the body.

FIG. 5a shows an item such as an article of clothing 60 that is marked using the unit 40, thus making it possible to identify the item.

This unit is attached to the item 60 in a particularly simple way by passing the tip 46 of the device 42 through this item, for example through an opening such as a buttonhole. Next, the tip is inserted inside the body 52 placed on the other side of the item, and the two elements of the unit are brought together so as to clamp the item between them, as shown in FIG. 5a.

With the tip being locked inside the body 52, the unit 40 cannot be separated from the item 60.

It will be noted that the unit 40 that is equipped with the active or passive elements mentioned above form a unit for protection against the theft of this item that also carries the name of antitheft tag or identification tag.

It is only possible to separate the unit from the item by unlocking the locking means of the tip 46, an operation that is implemented when the buyer of the item checks out.

Actually, the cash registers are equipped with unlocking means, for example in the form of particularly powerful magnets, making it possible to act on the ball mechanism that was described above.

It will be noted that the existing mechanical unlocking means can also be considered.

FIGS. 5b and 5c illustrate a variant embodiment of the protection unit of FIG. 5a in which the item 60 was omitted for the sake of clarity.

In this variant, the elements that are unchanged relative to FIG. 5a keep the same references.

The protection unit 61 comprises two parts 63 and 65 that are assembled with one another.

The part 63 is a head 62 that has a general shape of a mushroom or upside-down umbrella and that has two opposite surfaces 62a and 62b.

The tip 46 whose end 46a is embedded inside the head 62 extends perpendicularly from the surface 62a and is removed from the latter.

The part 65 is a protective body or box in an essentially hemispherical shape that is provided with an insertion opening 64 for the insertion of the tip 64 into the body and locking means arranged in the central cavity 56 and that prevents the removal of the tip after its insertion.

These means are identical to those described in relation to FIG. 5a.

The box 65 also comprises an annular chamber 66 that surrounds the central cavity 56 and in which are arranged the element(s) that participate in the detection of the passage of the unit 61 within the scope of a detection system.

The description of FIG. 5a also applies here.

The box 65 has an essentially flat plate 65a on its outer surface 65b and is topped with a projecting central portion 65c for working mechanically by interlocking with the central layout 67 that defines the cavity 56.

The opening 64 is located in the plate 65a.

The dome-shaped box has an opposite surface 65d.

This surface has a hollowed-out portion in which an element 68 that carries a printed zone and is cap-shaped is inserted.

This element has the same characteristics and functionalities as those of the element 50 of FIG. 50a.

A transparent protective cover 69 that also has a cap shape is superposed on the element 68 for filling in the hollowed-out portion of the box and thus to be mounted flush relative to the outer surface 65c of the box.

This arrangement does not add any space requirement to the protection unit.

This arrangement even makes it possible to install the head 62 behind the item to be protected (for example, the item 60 of FIG. 5a) instead of placing there the box that is bulkier.

This makes it possible, for example, to avoid deforming the item such as an article of clothing.

The assembly of the head and the box is facilitated since it is possible to put the item or the packaging behind the head, make the item or the packaging pass through the tip, and, next, bring the box against the tip that emerges from the item or the packaging so as to be inserted there.

FIG. 6 diagrammatically illustrates in axial cutaway a device 70 for marking an item according to a variant embodiment.

The device comprises a tip 72 that is topped by a head 74 in the upper part of which a housing 75 is provided that is open toward the top.

A transparent cover 76 is attached to the head by insertion in the housing provided in the latter.

As shown in FIG. 6, a passive element that is able to receive electromagnetic waves coming from outside of the device is installed in the housing.

This element 78 takes the form of, for example, a resonant LC-type circuit, and a number of electrical conductors that constitute this circuit are shown diagrammatically in cutaway in this figure.

It will be noted that this circuit is arranged at the bottom of the housing 75 and that an element 79 that has a form that is essentially similar to that of the cover 76 but with reduced dimensions for being able to be housed inside the latter is installed in the housing.

More particularly, this carrier element 79 of the printed zone is in contact, on the one hand, by means of the latter with the inside surface 76a of the cover, and is in contact, on the other hand, with the bottom of the housing by means of a skirt that extends from the surface that carries the printed zone.

The printed element 79 rests by its central part on a central bulge in which the shoulder 72a of the tip 72 is installed.

The transparent cover 76 comprises an outside surface 76b that is concave and allows the printed zone of the element 79 to appear.

It will be noted that the different forms imparted to the cover make it possible to obtain different visual effects, for example magnification, and even deformation, of the inscriptions that are present in the printed zone.

It will be noted that the protection offered by a transparent cover such as the one shown in FIG. 6 or in other figures makes it possible to have recourse to a printing technique that is less expensive than tampographic printing and is of better quality.

Actually, with the printed zone being protected from any mechanical contact with outside objects, it is only necessary that the printing be particularly resistant to mechanical rubbing and in a general way to wear and tear.

According to a variant, not shown, one or more active elements, able to emit electromagnetic waves toward the exterior of the device, can equip the head 74 in place of the passive circuit 78.

The emission of these waves can be carried out upon receiving electromagnetic waves coming from an outside source.

It will be noted in this connection that it is necessary to use an electrical supply, for example, in the form of a battery or else a so-called electronic alarm circuit that can be energized in a particularly simple way when it is subjected to electromagnetic waves.

It will be noted that the cover 76 according to a variant that is not shown can alternately have a convex outside surface analogous to the one illustrated in FIG. 5a.

According to one variant embodiment that is shown in FIG. 7a, a device 80 comprises a transparent protective cover 82 that is mounted on a head 84. The cover has, for example, a general shape of an open hollow basin that is turned over, and the head 84 is placed in the opening in such a way as to seal it.

An element 86 that carries at least one printed zone on an upper surface 86a is placed in the hollow of the cover between the inner surface 82a of the latter and the head.

It is thus locked in position.

The printed zone(s) is/are visible through the outer surface 82b of the cover.

The device also comprises a tip 88 that successively passes through the element 86 and the head 84 for emerging through the surface 84a of the latter. The cover thus covers the enlarged end 88a of the tip that is visible from the outside and rests against the surface 86a of the element 86.

A recess is provided in the inner surface 82a for housing therein the enlarged end 88a of the tip.

Such a device is particularly simple to produce: the element 86 and the head are successively slipped onto the tip 88, and then brought into contact with one another and rest against the shoulder of the enlarged end 88a, with the unit next being introduced into the hollow formed in the cover 82 and set, for example, in a removable way by clamping between the head and the inside flange of the cover.

It will be noted that, according to another variant shown in FIG. 7b, the printed element 86 is omitted, with the printed zone(s) being directly carried by the upper surface 84b of the head. The printing is actually done directly on the surface 84b.

The arrangement of the device 81 of FIG. 7b is thus simplified in advance.

It will be noted that the head 84, which has, for example, the shape of a disk or a token, is inserted and kept interlocked or wedged in the central part of the cover 82.

This arrangement makes it possible to easily manipulate the device.

The two elements 82 and 84 optionally can be glued or attached to one another in a different way, namely simply arranged one against the other without being attached.

FIG. 7c makes use of the same elements and the same references as those of the device of FIG. 7b.

However, in the device 83, the head 85 that has, for example, the shape of a disk or a token extends according to the largest dimension of the cover (which is, for example, in the shape of an upside-down dome or basin). The cover 82 thus rests by a peripheral edge 82c against a peripheral zone 85c of the printed head.

The printed zone is, for example, in the central zone of the head that is surrounded by the peripheral zone 85c.

The head 85 and the cover 82 may or may not be attached to one another to the extent where the tip 88 already allows their assembly.

This arrangement is particularly simple to produce.

It will be noted that the head 85 and the cover 82 can alternatively have different shapes that make it possible to arrange the printed zone that is carried by the head behind the transparent cover or, at any rate, behind the transparent part of the latter if it should be transparent only in one part alone. This possibility of partial transparency of the cover applies to all of the other embodiments and variants presented above and below.

FIG. 8 illustrates a variant embodiment of a marking and protection device 90 that integrates two liquid cartridges 92 and 94, for example produced in the form of ink-filled glass ampoules.

As already described and illustrated in other figures, the device 90 carries a head 95 that comprises an open housing 96 and a cover or porthole for transparent protection 97 that closes this housing by the top.

An element 98 that carries information/inscriptions printed on the surface of the top 98a is inserted between the cover and the bottom of the housing.

A tip 99 is attached in the raised central part 95a of the head.

The cartridges 92 and 94 are installed in two cavities with suitable shapes located on either side of the tip 99, in the central part 95a.

These cartridges are arranged on a level with the wall at the lower surface 95b of the head so that they are easily perforated or broken as soon as an ill-intentioned individual attempts to introduce an object between the device 90 and the protective body with which it is locked (as in the arrangement of FIG. 5a) to separate them.

It will be noted that the element 98 can be omitted in a variant, with the printed zone being that of the lower surface 97a of the cover.

FIGS. 9, 10 and 11 illustrate various embodiments of units according to the invention that involve a marking/protection device according to the invention.

Such a device can thus work with boxes of varied shapes existing in the business sector.

The units 100, 110 and 120 that are illustrated in these figures are used not only to mark an item, but also to protect it against theft as already mentioned above.

FIG. 12 also illustrates another variant embodiment of a marking/protection device according to the invention.

The device 130 diagrammatically shown in axial cutaway comprises a head 132 that is equipped with a tip 134 that extends axially from a first surface 132a.

From the side of the second opposite surface 132b, the head comprises a wall 136 that extends perpendicular to this surface in an axial extension direction that is shown by the vertical axis Z in the figure.

The wall 136 constitutes a peripheral flange, for example, in annular shape that defines a central inner cavity 138.

The surface 132b forms, in the central part of the cavity 138, a projection or bulge 140 in which the head of the tip 134 is located.

This projection 140 is used as a support to an element 142 that carries a printed zone and that has, for example, a disk shape.

The element 142 is, for example, analogous to one of the elements 28 of FIGS. 2a, 2b, 79 of FIG. 6, or 98 of FIG. 8.

A transparent protective cover or a transparent window 144, for example analogous to the one of FIGS. 3a, 3b, 4a and 4b, is mounted in a removable manner inside the central cavity 138 and is totally inscribed in the volume that is defined by this cavity.

The wall 136 that forms a peripheral flange extends axially beyond the cover (the height of the wall is thus greater than that of the cover) and thus constitutes an axial extension element for protection of the cover.

The device 130 that is provided with the protective element 136 protects the transparent cover 144 from most of the outer mechanical contacts (for example, in the case of being dropped on the ground or rubbing on a surface or else against another device) and avoids numerous scratches and damage on the upper surface 144a of this cover.

Actually, in the event of contact or impact of the device with an outside object, it is the element 136 that comes into contact with this object and not the cover that is set back axially. The device 130 is thus provided with a longer service life.

At least the part 136a that is generally the part designed to come into contact with the outside environment of the device can be designed from the outset to withstand, over time, the wear and tear and the rubbing and/or to be coated with a specific material for this purpose.

It will be noted that in other variants, not shown, the wall 136 can be replaced by portions of wall, separate or not, and even by other elements that are distributed on the periphery of the cover 144 and removed from one another.

Other protective elements, extending axially from the surface 132b of the head, can alternately be considered for preserving the transparent cover from external mechanical damage (impacts, rubbing, . . . ).

The number of these elements, their arrangement, their shapes, and their dimensions are adapted to effectively provide the protection of the cover. It is thus possible to provide, for example, three elements arranged at 120° around the cover. They can each have, for example, a gap shape.

It will be noted that a protective element of the transparent cover can also be provided when the cover and the printed zone are located on a protective body and not on the head that is equipped with the tip.

1. Device (10; 20) for marking an item for the purpose of its identification, comprising:
A tip (14; 24) designed to pass through the item to be marked or a packaging containing this item,
A head (12; 22) that has two opposite surfaces, with the tip extending from a first surface of the two surfaces,
characterized in that on the side of the second opposite surface, the head has a printed zone that is protected by a transparent protective cover (16; 30).

2. Device according to claim 1, wherein the head comprises at least one element (28) that carries the printed zone and that is arranged opposite the protective cover.

3. Device according to claim 2, wherein the head has a housing on the side of its second surface (22b), with said at least one carrier element of the printed zone being positioned in the housing.

4. Device according to claim 2, wherein said at least one carrier element (28) of the printed zone has the shape of a token.

5. Device according to claim 2, wherein said at least one carrier element (28) of the printing zone is arranged in a removable manner on the second surface (22b) of the head.

6. Device according to claim 1, wherein the printed zone is carried directly by the head.

7. Device according to claim 6, wherein the printed zone is carried directly by the second surface that is opposite to the head.

8. Device according to claim 1, wherein the protective cover (16; 30) is attached in a removable manner to the head.

9. Device according to claim 1, wherein the protective cover (16; 30) is attached in a permanent manner to the head.

10. Device according to claim 1, wherein the protective cover (16; 30) has an outside surface that is opposite to an inside surface that is opposite the second surface of the head, with the outside surface having one of the following geometries: flat, convex, concave, or convex and concave.

11. Device according to claim 1, wherein the tip and the cover extend axially or relative to the first and second surfaces of the head, with at least one extension element extending axially, from the second surface, beyond the protective cover, so as to protect the cover relative to a contact with an outside object.

12. Device according to claim 11, wherein said at least one extension element at least partially surrounds the cover.

13. Device according to claim 11, wherein said at least one extension element takes the form of a peripheral flange arranged around the cover.

14. Device according to claim 1, wherein it comprises at least one active or passive element that is able to emit electromagnetic waves toward the exterior of the device or to receive them.

15. Device according to claim 1, wherein it comprises at least one liquid-filled cartridge that is susceptible to being perforated.

16. Unit (40) for protection of an item against theft, comprising a marking device according to claim 1, and a protective body (52) that is provided, on the one hand, with an opening (54) for inserting the tip (46) of the device therein, and, on the other hand, locking means for preventing the removal of the tip after its insertion.

17. Unit for protection of an item against theft that comprises:
A head that has two opposite surfaces and a tip that is designed to pass through the item to be protected or a packaging that contains this item, with the tip extending from a first surface of the two surfaces,
A protective body that is provided with, on the one hand, an opening for inserting the tip therein and, on the other hand, locking means for preventing the removal of the tip after its insertion, with a printed zone being located on the protective body and protected by a transparent protective cover.

18. Protection unit according to claim 17, wherein at least one carrier element of the printed zone is arranged between the protective body and the protective cover.

19. Protection unit according to claim 17, wherein the protective body comprises a surface in which the opening for inserting the tip is located and an opposite surface where the printed zone and the protective cover are located.

20. Device according to claim 3, wherein said at least one carrier element (28) of the printed zone has the shape of a token.
